(19) United States
(12) Patent Application Publication
(10) Pub. No.: US 2002/0091819 A1
(43) Pub. Date: Jul. 11, 2002

(54) System and method for configuring computer applications and devices using inheritance

(76) Inventors: Daniel Melchione, Beaverton, OR (US); Victor Kouznetsov, Aloha, OR (US)

Correspondence Address: Jung-hua Kuo, Attorney At Law, PO Box 3275, Los Altos, CA, 94024, US

(21) Appl. No.: 09/755,525

(22) Filed: Jan. 5, 2001

(51) Int. Cl. G06F 15/16; G06F 15/173

(52) U.S. Cl. 709/224; 709/201

(57) ABSTRACT

A system and method using inheritance for the configuration, management, and/or monitoring of computer applications and devices via a computer network are disclosed. The method generally comprises determining a hierarchical tree structure based upon locations of devices in a network topology, each device being a node in the hierarchical tree structure, determining policies for each node in the hierarchical tree structure to be enforced by an agent corresponding to each node, the agent being in communication with the device and the resources corresponding to the device, and communicating the policy to the corresponding agent, wherein the policies corresponding to the resources of each device are selectively inherited along the hierarchical tree structure of the network directory.

### BACKGROUND OF THE INVENTION

1. Field of the Invention

The present invention relates generally to a system and method for the configuration, management, and/or monitoring of computer applications and devices. More specifically, a system and method using inheritance for the configuration, management, and/or monitoring of computer applications and devices via a computer network are disclosed.

2. Description of Related Art

A computer network linking together numerous computers and various other devices becomes increasingly more difficult, time-consuming, and costly to manage as the number and complexity of computers or other devices on the network increases. In addition, the devices on the network may be located in distant geographic locations, thereby adding to the complexity and cost for management of the network.

Management of the devices in a computer network may involve the setting of various configuration parameters for each user, device, software, application, or other electronic resources installed on the devices or otherwise available via the devices. Such configuration may include configuring the way the resources may communicate with each other as well as how the resources may be shared, accessed, secured, limited, updated, scanned, backed up, etc.

For example, it may be desirable to manage virus protection on a computer network by managing each computer as a separate entity. Typically, a network administrator is responsible for the management of the computer network. The network administrator may install the virus protection software application on a first server or device and configure the software application. The configuration for the first device may be copied for installation on all other devices. With each change or upgrade, the process must be repeated for each device on the network. Such a process is very tedious and time-consuming, particularly when the devices are at different physical sites. In addition, the large number of computers and sites in a large network under management increases the complexity of the process may increase disproportionately.

Furthermore, within a network, it is often desirable or necessary to specially configure certain individual devices to account for differences among the different devices such as in hardware and/or usage. With mass copying of a master configuration file, particularly in a subsequent modification to the configuration and/or update of the application, any customizations on individual machines are lost and an administrator must correctly add the customizations back manually. As is evident, initial installation and subsequent updating of the application and/or modifications to the control settings can be tedious and costly. Any customizations are even more difficult with increased risks for error and complexity in management.

Thus, it is desirable to provide a system and method that more effectively and efficiently configure, manage, and/or monitor devices of a network.

### SUMMARY OF THE INVENTION

A system and method using inheritance for the configuration, management, and/or monitoring of computer applications and devices via a computer network are disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below.

The method generally comprises determining a hierarchical tree structure based upon locations of devices in a network topology, each device being a node in the hierarchical tree structure, determining policies for each node in the hierarchical tree structure to be enforced by an agent corresponding to each node, the agent being in communication with the device and the resources corresponding to the device, and communicating the policy to the corresponding agent, wherein the policies corresponding to the resources of each device are selectively inherited along the hierarchical tree structure of the network directory.

The agent is in communication with the resources corresponding to the device and the policies to be enforced by the agent is applicable to the device and the resources of the device. The determination is performed by a policy orchestrator server by accessing data stored in a network directory and defining policies corresponding to and to be enforced upon the resources available to the devices. The policies corresponding to the resources of each device are selectively inherited along the hierarchical tree structure of the network directory.

The system for management of a network of devices and resources available to the devices via a computer network generally comprises a network directory defining a network topology of nodes corresponding to the network of devices and defining policies corresponding to and to be enforced upon the resources available to the devices, a policy orchestrator server in communication with the network directory, the policy orchestrator server being adapted to determine a hierarchical tree structure containing the nodes based upon location of each node in the network topology, determine a policy for each node in the hierarchical tree structure, and communicate said policy to the corresponding node, and an agent corresponding to each device in the network of devices. The agent is in communication with the policy orchestrator server and the resources corresponding to the device and is adapted to receive data from the policy orchestrator server and to enforce the policies corresponding to the resources. The policies corresponding to the resources of each device are selectively inherited along the hierarchical tree structure.

These and other features and advantages of the present invention will be presented in more detail in the following detailed description and the accompanying figures which illustrate by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram illustrating an overview of the policy orchestrator system;

FIG. 2 is a block diagram illustrating in more detail the policy orchestrator server, the LDAP server, and the management console;

FIG. 3 is a flow chart illustrating a process for directory management by the management console;

FIG. 4 is an exemplary screen shot illustrating details of a directory management display by the management console;

FIG. 5 is an exemplary screen shot illustrating details of a policy management display by the management console;

FIG. 6 is flow chart illustrating a process for policy management by the management console;

FIG. 7 is a block diagram illustrating a linked list that stores information parsed from point product policy files;

FIG. 8 is a block diagram illustrating a linked list that stores information relating to a scheduled task;

FIG. 9 is a block diagram illustrating the agent and its interactions with point products and with the policy orchestrator server;

FIG. 10 is a block diagram illustrating example of sites into which a network environment may be divided;

FIG. 11 is a block diagram illustrating details of the software architecture for the policy orchestrator server;

FIG. 12 illustrates an example of a computer system that can be utilized with the various embodiments of method and processing described herein; and

FIG. 13 illustrates a system block diagram of the computer system of FIG. 12.

### DESCRIPTION OF SPECIFIC EMBODIMENTS

A policy orchestrator system and method using inheritance for the configuration, management, and/or monitoring of computer applications and devices via a computer network are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Policy Orchestrator System Overview

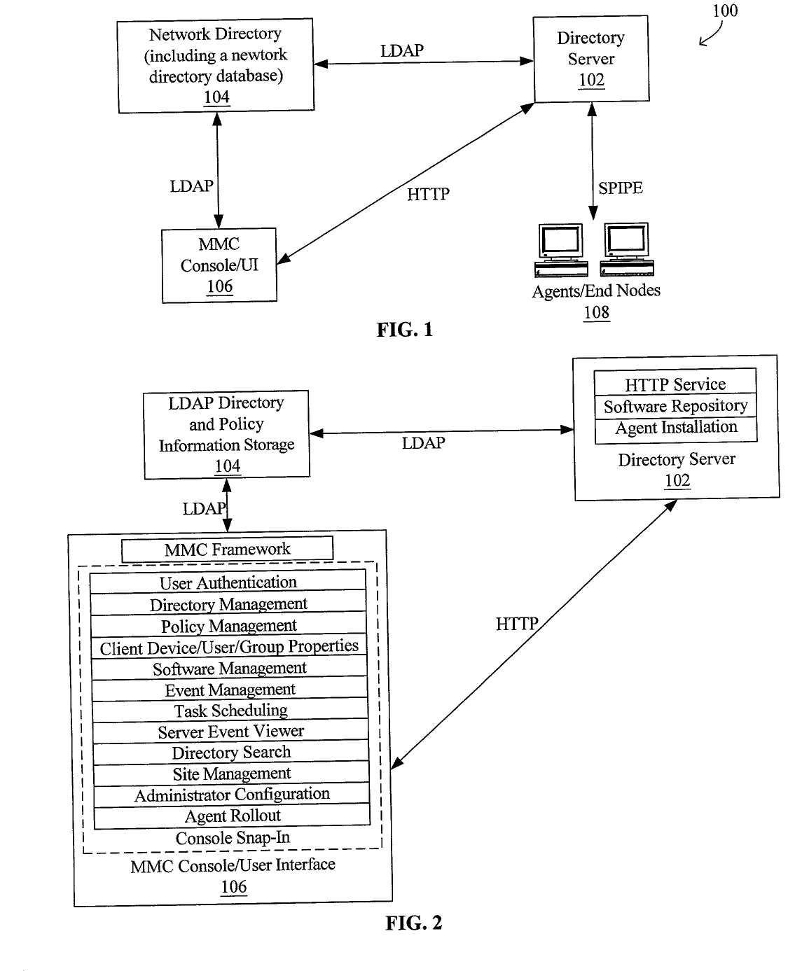

FIG. 1 is a block diagram illustrating an overview of the policy orchestrator system 100. As shown, the policy orchestrator 100 generally comprises a policy orchestrator server 102, a network directory server 104 such as an LDAP (Lightweight Directory Access Protocol) server, an MMC (Microsoft Management Console) console or user interface 106, and one or more agents 108.

The policy orchestrator server 102 is a central management component of the policy orchestrator system 100. Preferably, most data and information of the policy orchestrator system 100 such as properties from the agents 108 and the software policies, is stored in a centralized repository such as the LDAP server 104. In particular, the LDAP server 104 is the backend database for the policy orchestrator system 100 that includes an LDAP database serving as a centralized repository of directory and policy information.

The management console 106 is a user interface (UI) of the policy orchestrator system 100 and may be an MMC snap-in. The management console 106 allows a network administrator to perform various tasks such as distributing agents 108 via the policy orchestrator server 102 to client devices, modifying policies to be enforced at client devices by the agents 108, and/or scheduling tasks to be executed at client devices by the agents 108. The management console 106 typically does not persist any data locally other than network administrator login information. Rather, console data is preferably stored in the LDAP server 104.

Once the network administrator successfully logs in via the management console 106, the management console 106 retrieves information such as LDAP configuration information from the LDAP server 104 and/or information from the policy orchestrator server 102 as needed. The management console 106 then populates the directory tree and displays the directory tree in a scope pane. The management console 106 may also display details of the directory tree and/or software hierarchy for a selected node in a selected node directory pane. Additional information regarding each selected policy, property, event, or task for the selected node may be displayed such as in a details pane. Any modifications to the selected policy, property, event, or task for the selected node may be made via the details pane.

The management console 106 allows a network administrator to perform various tasks via the policy orchestrator server 102 such as distributing agents 108 to a local client device, creating and modifying policies implemented by the agents 108, and/or scheduling tasks that the agents 108 cause to be executed on the local client device.

Each agent 108 is typically a thin client or a small program that runs in the background of a client device such as a desktop computer. Client device refer generally to any machine that is managed by the policy orchestrator. The agent 108 collects system information and performs policy enforcement at the client level. The agent 108, in conjunction with the policy orchestrator server 102, monitors and records systems properties, records events, installs and uninstalls software, schedules executions, performs scheduled executions, and enforces installed software policies set by the network administrator via the management console 106.

The agent 108 may collect machine/system properties and product properties from point product or point product plug-ins and transmit the properties to the policy orchestrator server 102. A point product is any product such as a software application that is policy-enabled, i.e. controllable by the policy orchestrator system 100 using policies to manage the product. Properties of the point product generally refer to information provided by the point product such as the product version, engine version, and/or product configurations.

Each point product preferably includes a corresponding plug-in DLL (dynamic-link library) that resides with the point product on the local client device. The plug-in DLL serves as a communicator between the agent 108 and the point product and allows the agent 108 to collect properties and/or enforce policies. The plug-in DLL preferably also resides in a location such that the plug-in DLL corresponding to a particular point product can easily call other point product DLLs corresponding to other point products as necessary. Exemplary functionality of the plug-in DLL may include collection of product information such as product version, DAT version, and/or product configurations, enforcement of policies such as setting specific options and/or configuration for the point product, execution of scheduled tasks such as those scheduled via the management console, obtain task status such as tasks that are running or stopped, forcing termination of a task being executed by the point product, and/or release task identifier after the completion or other termination of the corresponding task such that the task identifier may be utilized for a different task.

Properties may be collected by the agent 108 by calling the point product plug-in DLL. For example, the agent 108 may periodically call every point product plug-in DLL, gather the properties of each point product, and store the gathered properties. The agent 108 may timestamp the stored properties and send the stored properties to the policy orchestrator server 102. The policy orchestrator server 102 may then update and save the properties in the LDAP database 104. The agent 108 may also collect events from an alert manager and forward the events to the policy orchestrator server 102.

Upon receiving a query or other message from the agent 108, the policy orchestrator server 102 transmits various data depending upon the message transmitted by the agent 108. Examples of data transmitted by the policy orchestrator server 102 to the agent 108 include policy updates, software installations, and/or scheduled tasks to the querying agent 108. The agent 108 enforces the policies at the local client device in response to receiving policies from the policy orchestrator server 102 and/or schedules and executes the scheduled tasks at the local client device in response to receiving a task scheduling from the policy orchestrator server 102.

The policy orchestrator server 102, LDAP server 104, the management console 106, and the agents 108 may utilize any communication scheme over the network under management. The policy orchestrator server 102 preferably communicates with the LDAP server 104 using LDAP v3 APIs, the console or user interface 106 using HTTP, and the agents 108 using SPIPE (secure pipes) based on HTTP. In particular, the policy orchestrator server 102 preferably includes an HTTP server that listens for the properties and requests of the management console 106 and the agents 108. In addition, the console 106 and the LDAP server 104 may also communicate using LDAP. In one example, agents 108 may communicate with the policy orchestrator server 102 on a configurable timed query basis.

SPIPE is a proprietary method for transmitting information in a secure manner using PGP (pretty good privacy) digital authentication methodology. SPIPE transfers packets through HTTP protocol. SPIPE HTTP protocol may be implemented using TCP/IP and IPX/SPX network protocols. SPIPE preferably supports the TCP/IP and/or IPX/SPX network protocols. SPIPE is preferably primarily utilized between the policy orchestrator server 102 and the agent 108 to ensure data integrity. In addition, SPIPE may utilize hierarchical decision-making to facilitate load balancing on the network. It is to be understood that any other suitable method for transmitting information, preferably in a secure manner, may be utilized.

To further ensure the security of the policy orchestrator system 100, each agent 108 preferably generates its public and private key pair at its first execution and sends the public key to the policy orchestrator server 102. The policy orchestrator server 102 stores the agent's public key in the LDAP server 104 and when the agent 108 sends a package to the policy orchestrator server 102, the policy orchestrator server 102 verifies the key signature of the packet using the public key stored in the LDAP, as is known in the art.

Although communication between the agent and server is typically a two-way communication, the agent 108 typically initiates the communication by sending a packet to the policy orchestrator server 102. The agent 108 may initiate communication by transmitting a packet containing current properties of the corresponding client device to the policy orchestrator server 102. When the agent 108 sends a packet to the policy orchestrator server 102, the policy orchestrator server 102 utilizes the public key of the agent 108 to authenticate the agent 108. On the other hand, when the policy orchestrator server 102 sends a packet to the agent 108, the policy orchestrator server 102 is verified before the packet is unpacked. When necessary or desirable, the policy orchestrator server 102 sends a policy or software deployment packet that the agent 108 enforces the policy or deploys a software.

The policy orchestrator system 100 utilizes the network directory such as one provided by an NDS (Network Directory Services) or the LDAP server 104 to provide a tree structure for inheriting policies such as configuration or control settings and/or scheduled tasks. In other words, the network directory provides a tree structure for inheriting control settings down to the individual applications on local client devices. Inheritance generally refers to a hierarchy of properties and settings in which the setting closer to the object being managed but higher than the object itself in the hierarchy have a higher priority than those further away. Thus a task setting set high in the directory tree can be replaced by a closer/lower setting. This hierarchy may be utilized to implement management by exception on the network in which the administrator may set general rules and then set more specific rules on a case by case basis.

Thus, by using inheritance and utilizing the actual network directory, any setting can be established at any level in the directory tree. By setting a new value at a lower level, a higher, more general policy can be overridden. By setting a policy higher in the tree, it applies to more of the network. At the same time, higher level policies can be easily changed without accidentally disturbing finer controls established closer to the point of applications because lower level policies overlay corresponding portions of high level policies.

By utilizing the network directory, the network managed by the policy orchestrator system 100 may be self-healing when modifications to the network are made. For example, if a local client device is moved from one site to another, the local client device searches up the network control directory tree for the closest administrator or administrative user. That closest administrator is typically the one most closely associated with the physical site being managed. Once the local client device locates its closest administrator, the applicable properties, policies, scheduled tasks, and the like may be enforced and implemented upon the local client device by the policy orchestrator system 100.

The policy orchestrator system 100 provides a management scheme based on inheritance of properties down the local hierarchical network management structure. The policy orchestrator system 100 may utilize an existing network management structure to distribute control settings and information. In addition, a single set of entries at the top of the management structure effects protection for the entire network tree. A local administrator can make adjustments to the policy set by the network administrator or by any administrator higher up in the directory tree as necessary and/or allowable by the network security limits. Typically, network security is managed within the network rather than within the user or management console of the product being managed.

Such a scheme provides the advantage that additional servers or management consoles are not necessary to effect the policies, although additional servers or management consoles may be utilized. In addition, multiple management consoles may exist on the network without the multiple consoles conflicting each other.

As is evident, the use of inherited control settings and the inheritance of those settings down the network directory tree structure allows the network management task easier, less complex, and more predictable.

The control settings may be configured to varying degrees of granularity. Granularity generally refers to a measure of how small an adjustment can be made to an existing rule without changing another setting or rule, whether related or not. The granularity of the control settings is an important consideration in the set up and configuration of the policy orchestrator. If the granularity is not sufficiently fine, there may be a day-to-day need to fine tune the network that may cause inadvertent blockages to inheritance. Such blockages can prevent high level changes intended to be migrated down throughout much or all of the directory tree from migrating to controlled objects. The blockages can thus cause the point products to be improperly managed. These blockages may not be easily detected and corrected. Alternatively, if the granularity is too fine, then control settings may need to be repeated as they are made, reducing the efficacy of the policy orchestrator system and resulting in additional steps for the network administrator. Appropriate levels of granularity occur when the control store database is in fourth normal or beyond form.

Generally, broad policies are set higher in the tree while lower level policies are be set at the level of the individual local device. For a virus control software managed by the policy orchestrator system 100, for example, a broad policy may be a policy to scan all executable files for viruses, clean the file if possible or quarantine the file if the file cannot be cleaned upon detecting a virus, and send infection reports to the network administrator by default. A mid-level policy may be a policy to report all infections to the local administrator and may be set at the location level. A low-level policy may be a policy to delete any infected files of a specific user or local client device that may be set at the level of the specific user and/or specific local client device.

The hierarchical control store of the policy orchestrator system 100 preferably utilizes a high performance object based implementation. One result of such an implementation if that the application itself becomes independent of its management control store. If a control store separate from the network directory were to be implemented, then users and resources would undesirably need to be managed twice: once in the network and again in the control for the resource. In addition, by integrating the control store into the network management infrastructure, duplication of management work is eliminated and the control hierarchy becomes self-healing.

FIG. 2 is a block diagram illustrating in more detail the policy orchestrator server 102, the LDAP server 104, and the management console 106. As shown, the policy orchestrator server 102 includes an HTTP service, a software repository, and an agent installation module. The HTTP service module is utilized by the management console 106 to display information. The software repository contains a repository of the point product software. In addition, the agent installation module may process agent installation requests sent to the policy orchestrator server 102 for processing. The agent installation module of the policy orchestrator server 102 may include an agent installation executable file that is transmitted to a target client device and run as a service program on the target client device for agent self-installation. For example, the network administrator may send an agent installation program to the client device via the management console 106 and via the policy orchestrator server 102 such as in an electronic mail transmission. Alternatively, the network administrator may push agent installation programs to desired client devices such that those client devices may execute automatic program installations.

The executable file may be executed by the remote server such as in the case where the target machine is running Windows NT. Alternatively, rather than having a self-installation of the agent 108, the end user may execute the agent installation program. The agent installation program preferably sets the agent directory's user permissions to read-only for the end user and full access for the network administrator.

The functionality of the policy orchestrator server 102 may generally include agent property/policy management, storing and updating agent properties to the LDAP server 104, replicating a software repository, installing agents 108 at client devices, logging of policy orchestrator server events, and/or deploying of software, policies and/or scheduled tasks at the client devices. Examples of events that the server logs include “Fail to push install agent to the local device XXXX.”

When an agent 108 communicates with the policy orchestrator server 102 for the first time, the initial agent message preferably includes agent properties and the agent public key that the policy orchestrator server 102 stores in the LDAP server 104. As the policy orchestrator server 102 receives any subsequent messages from the agent 108, the policy orchestrator server 102 verifies the agent signature and performs a corresponding action depending upon the content of the agent message. The agent property/policy management functionality may generally include creation of a computer entry corresponding to the agent 108 in the LDAP database of the LDAP server 104, agent public key management, update of properties of the agent 108, and/or the creation of task, policy, site information files, preferably with timestamps. Typically, the network under management are divided into various sites that may be individually or collectively controlled.

LDAP Directory of the LDAP Server 104

The LDAP directory of the LDAP server 104 contains entries making up components of the network under management. Each LDAP directory entry may be categorized as a group, user, or computer. The network administrator may configure the LDAP directory to represent the corporate network. In one example, each group may contain any combination of users, computers, and/or other groups as its child nodes. Each user may contain computers and computer are the leaf nodes with no child. The scope pane may display various nodes such as the policy orchestrator root, the directory root, group, user, computer, software root, software node, and/or software package.

When the LDAP server 104 is initially run, the LDAP is preferably populated with initial data. The initial data may include information relating to each site, applicable protocols, mail subsystems, and/or the database connection and/or the events.

The LDAP directory information may be stored in a root in the LDAP. The value of the base DN (distinguished name) for the directory tree may be combined with the value of the root of the policy orchestrator server 102 to form the DN of the directory root. A default policy for each point product software is stored as the policy of the directory root as all the nodes under it inherit the default policy by default as will be described in more detail below. Similarly, the information relating to each point product installed in the software repository of the policy orchestrator server 102 is preferably stored in a separate root. Combining the value of the base DN for the software tree and the root of the policy orchestrator server 102 forms the DN of the software root. The policies may be stored in a separate root and links to these policies may be stored in the actual directory nodes. The values of the base DN for the policy tree may be combined with the value of the root of the policy orchestrator server 102 to form the DN of the policy root.

The requests for all the agent package installations may also be stored as a separate request root. Combining the value of base DN for agent installation request tree and the root of the policy orchestrator server forms the DN of the request root. The policy orchestrator servers 102 may periodically check this root for entries and transmit the agent packages to the corresponding client devices.

Management Console/User Interface 106

The management console 106 allows the network administrator to perform various tasks such as modifying the LDAP directory by adding and/or deleting groups, users, and/or computers from the network, configuring the LDAP, managing software, configuring point products by setting and enforcing policies and properties, scheduling tasks to be performed, setting up software or silent installations, monitoring events and setting tasks over the network.

As shown, the management console/user interface 106 may comprise an MMC framework and a console snap-in. In particular, the console snap-in may include various modules such as user authentication, directory management, policy management, client device/user/group properties, software management, event management, task scheduling, server event viewer, directory search, site management, administrator configuration, and agent rollout modules.

User Authentication Module

The user authentication module of the management console facilitates in authenticating the network administrator when the network administrator first runs the management console 106. In particular, the management console 106 may request as input the server name, administrator's user name and password, and/or port number, such as HTTP port 80. With these inputs, the management console 106 may connect to the specified policy orchestrator server 102 using the specified port number to download information for the corresponding site. The site information may include information relating to the master site server for the site that contains the LDAP server 104. In addition, the user name and password may be utilized to bind to the LDAP server 104. Once the network administrator is authenticated, the management console 106 downloads initial data such as the directory tree and installed software information using LDAP.

LDAP Directory Management Module

The LDAP directory management module of the management console 106 retrieves, populates, and displays information from the LDAP server 104 and/or policy orchestrator server 102 in the console tree that may comprise a directory tree and a software hierarchy. More specifically, the management console 106 may include a scope pane in which the directory tree and the software repository are displayed as well as a details or result pane in which more detailed information for a selected node of the LDAP directory tree in the scope pane is displayed. The LDAP directory management module of the management console 106 retrieves the directory tree from the LDAP database. When a user selects a node to expand, a list of the children of the selected node may be displayed, for example.

The LDAP directory management module of the management console 106 causes any modifications such as those made by the administrator to be stored or otherwise written to the LDAP server 106. For example, the LDAP directory management module may facilitate the network administrator in adding new users, computers, and groups as well as in renaming or deleting existing users, computers, and groups.

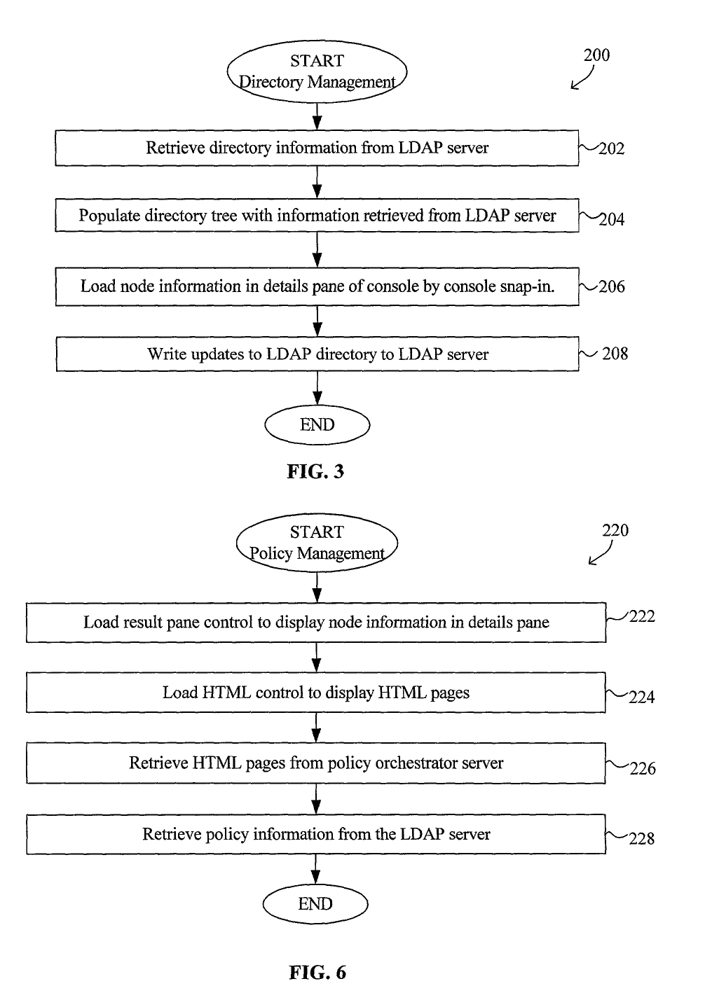

FIG. 3 is a flow chart illustrating a process 200 for directory management by the management console. In particular, at step 202, the management console retrieves directory information from the LDAP server. At step 204, the management console populates the scope pane with nodes of the directory tree with the information retrieved from the LDAP server. Next, at step 206, the management console loads information for a selected node in a details pane of the management console. At step 208, the management console writes any updates to the LDAP directory to the LDAP server.

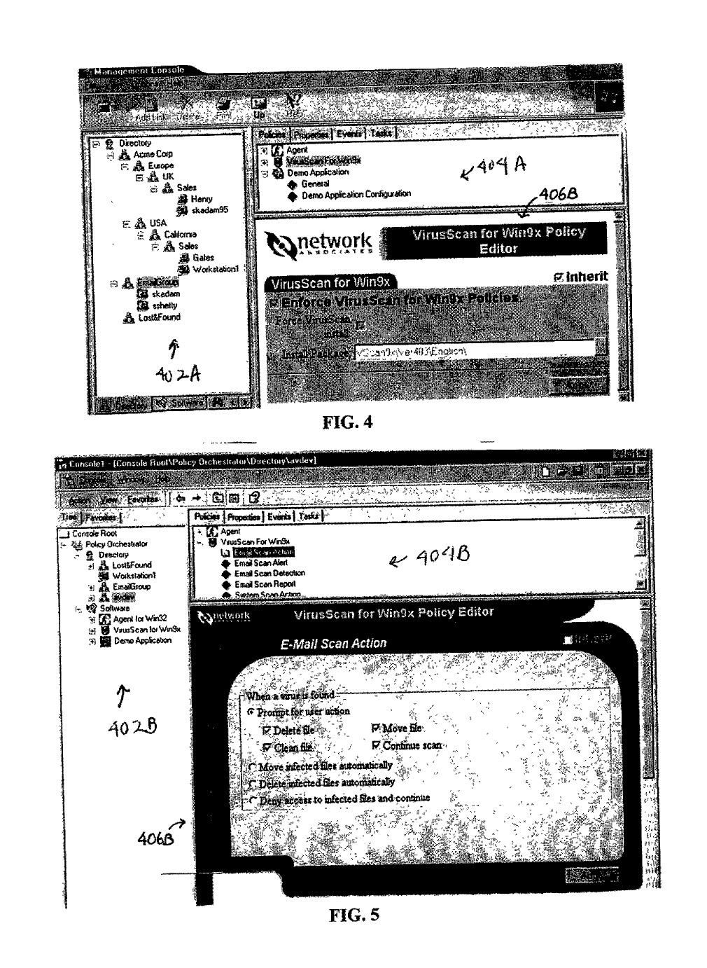

FIGS. 4 and 5 are exemplary screen shots illustrating details of the directory management display by the management console. As shown, the directory management display may include a scope pane 402, a selected node directory pane 404, and a details pane 406. The scope pane 402 generally display the directory tree for the policy orchestrator system as populated by the management console. If a node is selected, such as the “avdev” node as shown, the node may be highlighted in the directory tree in the scope pane 402 and the details of the directory tree and/or software hierarchy for the selected node may be displayed in the selected node directory pane 404.

Policy Management Module

The policy management module of the management console 106 facilitates the administrator in managing the policies to be enforced upon the point products by the agents 108. In particular, the policy management module allows the network administrator to define the policy for each point product such that the defined policies can be enforced over the entire or a selective portion of the network or over one or more individual computers. Policies are inherited and, at each level, a decision can be made whether to enforce a given policy at that level. In other words, by default, policies are inherited top down from the parent but a decision can be made not to enforce the policy below a certain level or only at a given level. Policies for each point product can be configured for each user, group, or computer. After a policy is configured, the policy orchestrator server 102 and agent 108 enforce the policy at the client device. Modifications to a policy may be made by selecting a group, user, or computer and modifying the necessary attributes for the specified application via the management console 106.

FIG. 6 is a flow chart illustrating a process 220 for policy management by the management console. In particular, at step 222, the management console loads the result pane control to display node information in the details pane. At step 224, the management console loads HTML control to display HTML pages. At step 224, the management console retrieves HTML pages from the policy orchestrator server. At step 228, the management console retrieves policy information form the LDAP server 102.

Each point product that is installed in the software repository of the policy orchestrator server 102 may contain a product template file. A product template file generally defines various option categories for the given product and contains information about the different tasks that can be scheduled for the point product software on the client device. When the management console 106 is executed, the product template files of all the installed point products are preferably downloaded. These files may be parsed and the information is stored in a linked list.

As noted above, the policy orchestrator server 102 provides the HTTP service that serves up web pages for policy management. The HTML service may be used to display web pages form the policy orchestrator server 102. Displaying a policy may entail a twostep process in which an HTML page is first retrieved from the policy orchestrator server 102. The HTML page preferably contains only page formatting information and attributes with no values. Once retrieved, the HTML page is then populated with data retrieved from the LDAP server 104. The result pane control uses the connection and DN information from the currently selected node to retrieve policy information from LDAP server 104. If any updates to the policy are made, the updates are written to LDAP server 104.

Each time the administrator changes the selection in the scope pane, the policy management module of the management console 106 may recompile the policy for the selected node. The policies for the different nodes are stored under a separate root in the LDAP. For example, all default policies for all point products in the policy orchestrator server 102 may be stored under the root of the LDAP directory root.

Each policy is read from the LDAP 104, starting with the policy for the currently selected node and continuing with the policy of each parent node until the policy of the directory root node is reached. The policy is then parsed and saved as a linked list, as shown in FIG. 7. As shown, the linked list 190 includes the policy 192 for the selected node, followed by the policy 194 of its immediate parent node as well as the policies of any other parent nodes. The final component of the linked list 190 is preferably the default policy 196 for the directory root node.

Referring again to FIGS. 4 and 5, additional information regarding a policy, property, event, or task for a point product or other node selected from the selected node directory pane 404 may be displayed in the details pane 406. In FIG. 4, the details pane 406A contains a policy editor for the “VirusScan for Win9x” point product selected and shown highlighted in the selected node directory pane 404A. Similarly, in the exemplary screen shot shown in FIG. 5, the details pane 406B contains a policy editor for the Email Scan Action selected and highlighted in the selected node directory pane 404B.

Any modifications to the selected policy, property, event, or task for the selected node may be made via the details pane 406. As shown, the network administrator may specify various e-mail scan policies and/or actions for the VirusScan point product via the policy editor displayed in the details pane 406.

Properties Module

Referring again to FIG. 2, the client device/user/group properties module of the management console 106 facilitates in managing the properties of, for example, the client device, user, group, computer, and/or site. For example, the point products managed by the agent 108 on a given client device may each have its set of defined properties. These defined properties may be transmitted across the policy orchestrator server 102 to be stored in the LDAP 104 via the management console 106. In addition, properties for each user may be defined by the network administrator via the properties module of the management console 106. Exemplary end user properties include email type and email address.

Software Management module

The software management module of the management console 106 facilitates in the installation and uninstallation of point products. For example, a point product may be installed by the software management module of the management console 106 on a client device in any suitable manner such as with the use an installation package file. In a preferred embodiment, the installation package file may be stored by the policy orchestrator server 102 and contain various information such as information relating to the point product to be installed, files relating to the default policy management and/or the actual policy management of the point product to be installed, and/or information relating to the location of the installation files of the point product.

To install the point product, the software management module of the management console 106 may obtain the installation package file, such as from the policy orchestrator server 102, copy the file relating to installation and management of the point product to the HTTP server of the policy orchestrator server 102, and update the LDAP with the corresponding point product entry in the LDAP server 104. When a corresponding agent 108 receives a product package for installation, the installation may be performed in any suitable manner. For example, the agent 108 may perform a general installation in which the agent 108 only carries out the commands of the product package. Alternatively, upon receiving the product package, the agent 108 may call a pre-install DLL such that the actual installation is performed within a pre-install DLL. As another example, the agent 108 may receive the product package with the install command and after installation, the install program reports the successfulness of the installation.

The software management module of the management console 106 may uninstall an installed point product in any suitable manner. For example, to uninstall a point product, the software management module 106 may delete a file relating to installation and management of the point product at the HTTP server of the policy orchestrator server 102 as well as delete the corresponding entry from the LDAP at the LDAP server 104.

Event Management Module

The event management module of the management console 106 facilitates in managing the events generated by the agent 108 that are preferably stored by the policy orchestrator server 102 in the LDAP database 104. Examples of types of events include information, warning, and error. Each event may be stored as a separate child entry under the corresponding the computer.

Task Scheduling Module

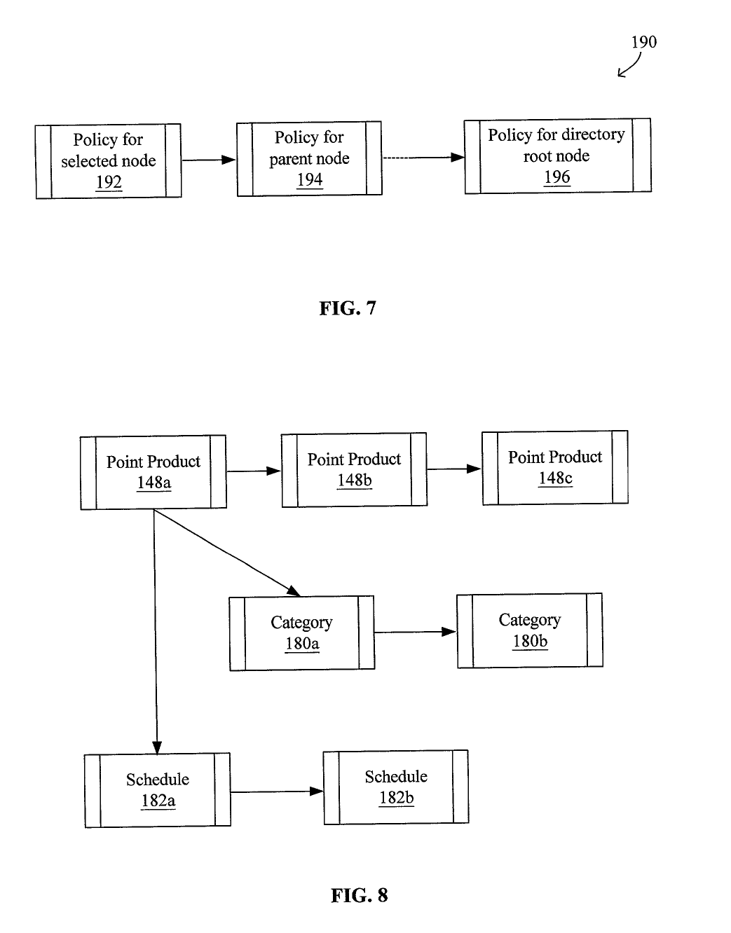

The task scheduling module of the management console 106 allows the administrator to select a group, user, or computer node such as from the directory tree and to schedule a task for the selected node by specifying, for example, the task name, task options, and scheduled execution time and/or frequency. Each point product can define different tasks that can be scheduled to run on the client machines. In particular, the point products can define the task name, the configuration HTML file, and/or the default configuration file. The information relating to the scheduled task may be stored in a linked list as shown in FIG. 8. As shown, point product 148a may be linked to a category 180a, which is in turn linked to category 180b, and a task schedule 182, which is in turn linked to task schedule 182b. In addition, the point product 148a is linked to point product 148b which is in turn linked to point product 148c.

Server Event Viewer, Directory Search, and Site Management Modules

The server event viewer module of the management console 106 facilitates in displaying of server events stored by the policy orchestrator server 102 for viewing by the administrator. The directory search module of the management console 106 facilitates the administrator in searching through the LDAP. In addition, the site management module of the management console 106 facilitates the administrator in management of the various sites into which the network under management may be preferably divided.

Administrator Configuration Module

The administrator configuration module of the management console 106 allows the policy orchestrator administrator to add, modify, and/or remove users from the system. The agent rollout module of the management console 106 allows the administrator to select one or more users, computer, or groups via the management console 106 for agent rollout.

Agent 108

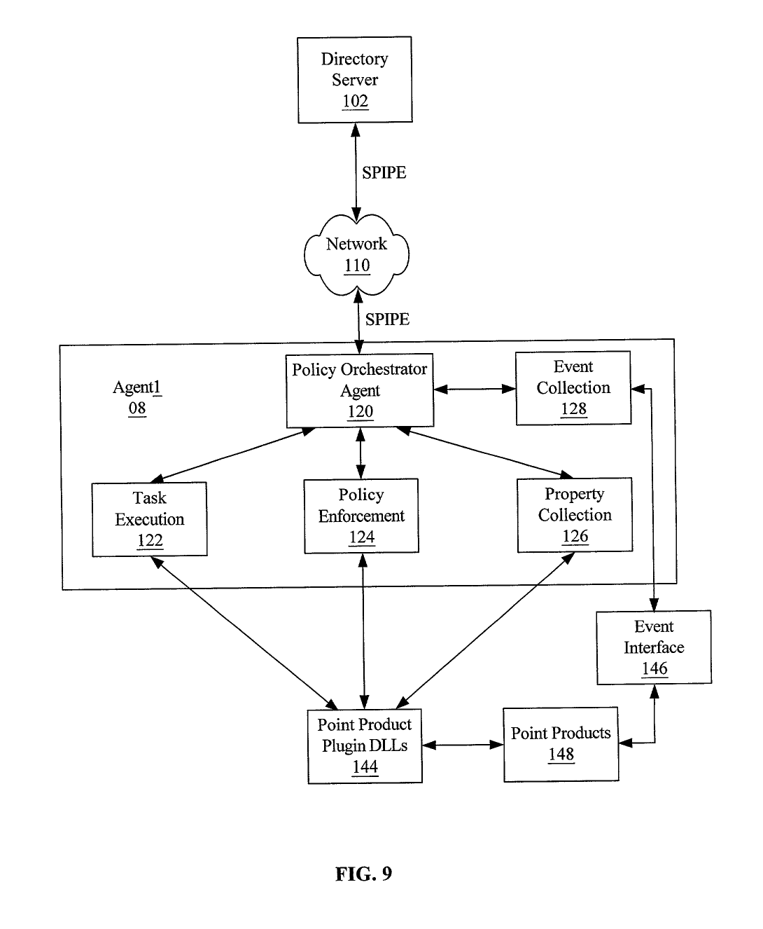

FIG. 9 is a block diagram illustrating the agent 108 and its interactions with the point products and with the policy orchestrator server 102 in more detail. As shown, the agent 108 generally comprises a policy orchestrator agent 120, a task execution module 122, a policy enforcement module 124, a property collection module 126, and an event collection module 128. The policy orchestrator agent 120 may communicate with the policy orchestrator server 102 via a network 110 using any suitable communication protocol such as SPIPE. The network 110 is preferably an intranet but may be an extranet or the Internet. The policy orchestrator agent 120 may also communicate with each of the task execution, policy enforcement, and property collection modules or engines 122, 124, 126. Each of the task execution, policy enforcement, and property collection modules 122, 124, 126 may in turn communicate with the point product plug-in DLLs 144 that in turn communicate with the point products 148. The point products 148 may communicate with the event collection module 128 via an event interface 146.

Scheduled task executions may be carried out by utilizing the task execution module 122, the policy enforcement module 124, and the plug-in DLL 144. New or modified policies and/or tasks are sent to the policy enforcement module 124 of the agent 108 via the network 110, the policy orchestrator server 102, and the management console 106. Preferably, the policy enforcement module 124 enforces the software policies at the local client device while the task execution module 122, in conjunction with the point product DLL 144, causes the point product 148 to execute the tasks. The agent 108 calls the policy enforcement module 124 to cause the plug-in DLL to read task settings for the specific point product and to execute the task according to the settings. The task settings, for example, can be the settings of the management console and/or the point product.

It is noted that when relatively minor upgrades of the point products and/or localized versions of the same point products are installed, the policy relating to the corresponding point products are preferably preserved. In the case of a relatively major upgrades of the point products are installed, it may be desirable for the previous policies to be replaced by the policy as determined through inheritance.

The property collection module 126 of the agent 108 may collect properties by calling a DLL of each point product periodically. In particular, the property collection module 126 gathers and stores the properties of the corresponding point product and transmits the properties to the policy orchestrator server 102 via the network 110. The policy orchestrator server 102 then updates the properties and saves the properties in the LDAP database 104.

Event data, such as “Virus Found” and “File Cleaned,” may be sent from the point product to the event collection module 128 of the policy orchestrator agent 108 via the event interface 146. The agent 108 collects and stores the event data and sends the stored event data to the policy orchestrator server 102 via the network 110.

Network Sites

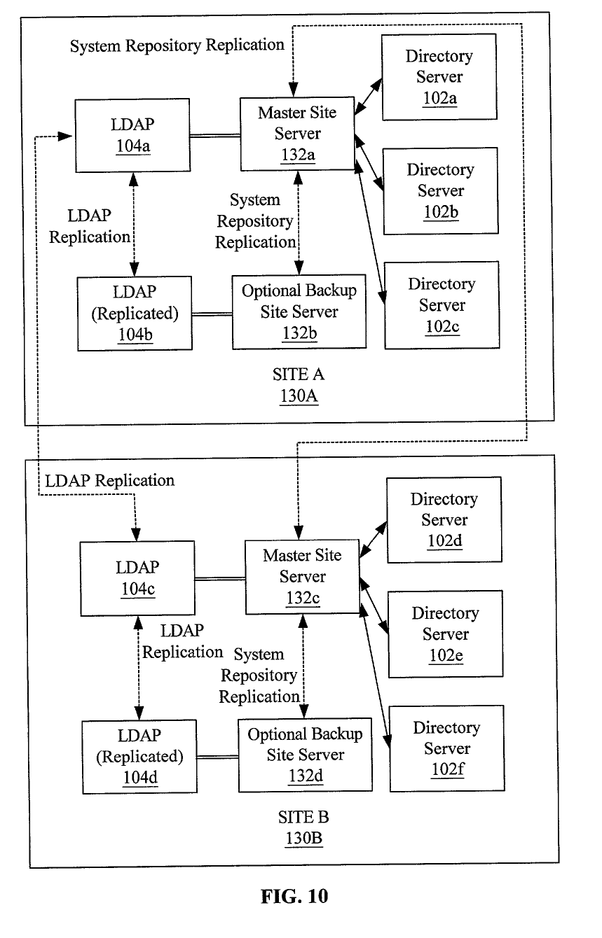

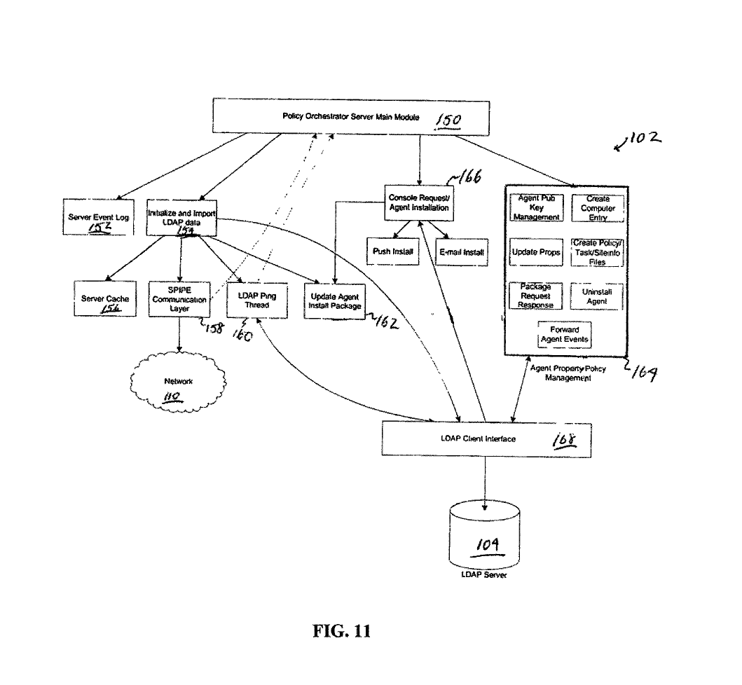

FIG. 10 is a block diagram illustrating the various sites such as site 130A and site 130B into which a network environment is preferably divided. Using site 130A as an example, each site 130A may comprise a master site server 132a and an optional backup site server 132b. The remainder of the servers at the site 130A may be standard policy orchestrator servers 102a, 102b, 102c. The site 130A may also include an LDAP server 104a that typically resides at the master site server 132a. The master site server 132a replicates the LDAP server 104a and the software repository information between or among various sites, such as by using the HTTP server and secure sockets layer (SSL). The optional backup site server 132b typically contains all the functionality of the master site server 132a but does not replicate the backup servers among the various sites. In the event that the master site server 132a is down, the backup site server 132b may act as the master site server. However, typically no LDAP replication and no software replication would be done among the various sites.

The regular policy orchestrator servers 102 need not include an LDAP server 104 installed on the same machine. Thus, the regular policy orchestrator servers should be connected to the master site server in order to store and retrieve the LDAP database. However, each policy orchestrator server preferably has software repository and replicate with other policy orchestrator servers within the site.

Site information illustrates the policy orchestrator network setup. Site information can be configured from the console and the date is recorded in the LDAP database. Site information is also sent to all the agents. The agent uses the site information to connect to the appropriate policy orchestrator server.

Policy Orchestrator Server 102

FIG. 11 is a block diagram illustrating details of the software architecture of the policy orchestrator server 102. The policy orchestrator server 102 generally comprises a main server module 150, a server event log 152, an initialize and import LDAP data module 154, a server cache 156, a SPIPE communication layer 158, a LDAP ping thread 160, an update agent install package 162, an agent property and policy management module 164, console request/agent installation module 166, and an LDAP client interface 168. The LDAP ping thread 160 periodically checks the LDAP server 104 to determine if site information has changed and to confirm that the LDAP server 104 is running. As noted above, the console request/agent installation module 166 may achieve installation of an agent and/or any suitable point products at the client device by transmitting the installation package in an electronic mail transmission or by a push installation.

The agent property policy management module 164 may generally include various sub-modules such as agent public key management, create computer entry, update properties, create policy/task/site information files, package request response, uninstall agent, forward agent events sub-modules.

Determination of Inheritance

Any suitable method may be utilized to determine the heritage or inheritance of an object in the directory tree. Preferably, the inheritance determinations are dynamic and carried out by the management console. In one example of an inheritance determination method, the determination result (i.e., the control store) is first initialized to null. The control values or settings of the network tree are then read starting at the root and ending at the node being managed. At each node where control entries are found, these control values are written into the control store. In writing the most recently found control values, previously written conflicting control values in the control store are typically overwritten. After the determination is complete, the result is a cumulative inheritance of the object. This method of determining the inheritance is relatively simple to implement.

As another example of an inheritance determination method, the determination result (i.e., the control store) is similarly first initialized to null. The control values or settings of the network tree are then read starting at the node being managed and ending at the root. If the found control value was already been set or written in the control store, the located control setting is ignored. In other words, the previously written conflicting control values prevail over more recently located control values. The traversal up the directory tree from the node being managed is complete after all possible values have been set or after the root is reached and read. It is noted that it may be desirable to only inherit from a certain number of levels above the managed object or to stop at some defined network boundary. Although this method of determining the inheritance is relatively more complex than the previous example, this method of determining the inheritance opportunities to minimize and optimize network accesses.

To determine inheritance for users, the control values or settings of the network tree are first determined for the local client device. The device control values are then overlaid that with the inheritance of the user. Typically, the device inheritance includes settings for the device and settings pertaining to users in the device's container. In the absence of other policies, the policy in effect at the device would also apply to the users. However, if a different policy for the user or somewhere on the user path exists, that different policy will override the corresponding components of the device's policies as necessary.

In the case where no value has been set for a particular parameter, a default value may be supplied by the management system. Alternatively although not preferred, the object being managed may supply the default values for missing parameters.

Depending upon the object being managed and the intended use of the information, there may be multiple paths of inheritance for obtaining control store information. The particular path chose affect how control store information is inherited.

In a virus protection point product software example, on-access scans are associated with a user such that if a user accesses a remote server and attempts to write an infected file, the user's local administrator should be notified. If the same user accesses a remote server and tries to read an infected file, then the remote server's administrator, the infected file's owner and/or the administrator of the file's owner may be notified of the infection. Alternatively, on-demand-scans of local files are tasks initiated at the local client device on a predetermined schedule. Typically, only a computer or other device, e.g., the local client device that may be shared by several users, is associated with on-demand-scans task. Thus, all components of the on-demand-scans control are typically be inherited from the path between the root and the node being managed.

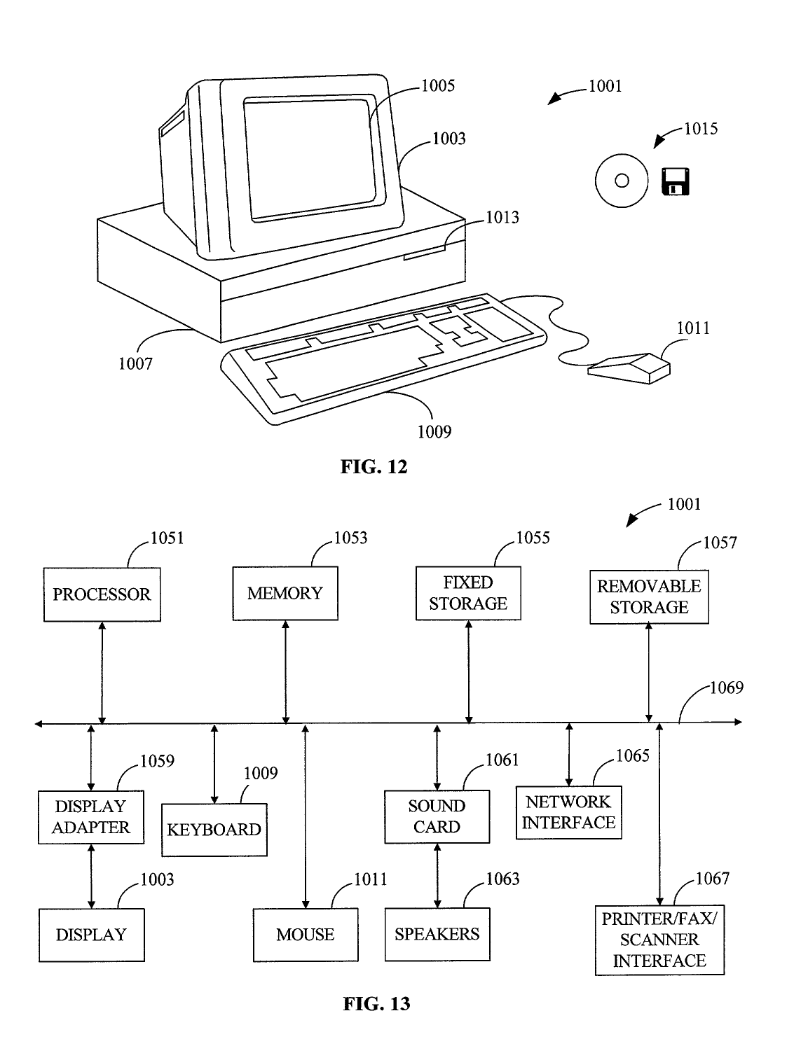

FIGS. 12 and 13 illustrate a schematic and a block diagram, respectively, of an example of a general purpose computer system 1000 suitable for executing software programs that implement the methods and processes described herein. The architecture and configuration of the computer system 1000 shown and described herein are merely illustrative and other computer system architectures and configurations may also be utilized.

The illustrative computer system 1000 includes a display 1003, a screen 1005, a cabinet 1007, a keyboard 1009, and a mouse 1011. The mouse 1011 can have one or more buttons for interacting with a GUI (graphical user interface) that may be displayed on the screen 1005. The cabinet 1007 typically house one or more drives to read a computer readable storage medium 1015, system memory 1053, and a hard drive 1055, any combination of which can be utilized to store and/or retrieve software programs incorporating computer codes that implement the methods and processes described herein and/or data for use with the software programs, for example. Examples of computer or program code include machine code, as produced, for example, by a compiler, or files containing higher level code that may be executed using an interpreter.

Computer readable media may store program code for performing various computer-implemented operations and may be encompassed as computer storage products. Although a CD-ROM and a floppy disk 1015 are shown as exemplary computer readable storage media readable by a corresponding CD-ROM or floppy disk drive 1013, any other combination of computer readable storage media can be utilized. Computer readable medium typically refers to any data storage device that can store data readable by a computer system. Examples of computer readable storage media include tape, flash memory, system memory, and hard drive may alternatively or additionally be utilized. Computer readable storage media may be categorized as magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. Further, computer readable storage medium may also encompass data signals embodied in a carrier wave, such as the data signals embodied in a carrier wave carried in a network. Such a network may be an intranet within a corporate or other environment, the Internet, or any network of a plurality of coupled computers such that the computer readable code may be stored and executed in a distributed fashion.

Computer system 1000 comprises various subsystems. The subsystems of the computer system 1000 may generally include a microprocessor 1051, system memory 1053, fixed storage 1055 (such as a hard drive), removable storage 1057 (such as a CD-ROM drive), display adapter 1059, sound card 1061, transducers 1063 (such as speakers and microphones), network interface 1065, and/or scanner interface 1067.

The microprocessor subsystem 1051 is also referred to as a CPU (central processing unit). The CPU 1051 can be implemented by a single-chip processor or by multiple processors. The CPU 1051 is a general purpose digital processor which controls the operation of the computer system 1000. Using instructions retrieved from memory, the CPU 1051 controls the reception and manipulation of input data as well as the output and display of data on output devices.

The network interface 1065 allows CPU 1051 to be coupled to another computer, computer network, or telecommunications network using a network connection. The CPU 1051 may receive and/or send information via the network interface 1065. Such information may include data objects, program instruction, output information destined to another network. An interface card or similar device and appropriate software implemented by CPU 1051 can be used to connect the computer system 1000 to an external network and transfer data according to standard protocols. In other words, methods and processes described herein may be executed solely upon CPU 1051 and/or may be performed across a network such as the Internet, intranet networks, or LANs (local area networks), in conjunction with a remote CPU that shares a portion of the processing. Additional mass storage devices (not shown) may also be connected to CPU 1051 via the network interface 1065.

The subsystems described herein are merely illustrative of the subsystems of a typical computer system and any other suitable combination of subsystems may be implemented and utilized. For example, another computer system may also include a cache memory and/or additional processors 1051, such as in a multi-processor computer system.

The computer system 1000 also includes a system bus 1069. However, the specific buses shown are merely illustrative of any interconnection scheme serving to link the various subsystems. For example, a local bus can be utilized to connect the central processor to the system memory and display adapter.

The computer system 1000 may be illustrative of the computer system of the policy orchestrator server and/or the local devices or agents.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

What is claimed is:

1. A system for management of a network of devices and resources available to the devices via a computer network, comprising:
a network directory defining a network topology of nodes corresponding to the network of devices and defining policies corresponding to and to be enforced upon the resources available to the devices;
a policy orchestrator server in communication with the network directory, the policy orchestrator server being adapted to determine a hierarchical tree structure containing the nodes based upon location of each node in the network topology, determine a policy for each node in the hierarchical tree structure, and communicate said policy to the corresponding node; and
an agent corresponding to each device in the network of devices, the agent being in communication with the policy orchestrator server and the resources corresponding to the device, the agent being adapted to receive data from the policy orchestrator server and to enforce the policies corresponding to the resources,
wherein the policies corresponding to the resources of each device are selectively inherited along the hierarchical tree structure.

2. The system for management of a network of devices and resources via a computer network according to claim 1, further comprising a management console in communication with the network directory and the policy orchestrator server for providing a user interface, the management console being adapted to selectively display the hierarchical tree structure and the policies stored in the network directory.

3. The system for management of a network of devices and resources via a computer network according to claim 2, wherein the management console dynamically determines the policy of a selected node of the hierarchical tree structure.

4. The system for management of a network of devices and resources via a computer network according to claim 3, wherein the management console dynamically determines the policy of the selected node by reading the policies of nodes along a path of nodes from a root of the hierarchical tree structure to the selected node and wherein the management console overwrites previously written policies upon reading conflicting policies at each node along the path of nodes.

5. The system for management of a network of devices and resources via a computer network according to claim 3, wherein the management console dynamically determines the policy of the selected node by reading from the policies of the selected node up to the policies of a root of the hierarchical tree structure.

6. The system for management of a network of devices and resources via a computer network according to claim 1, wherein each policy is selected from the group consisting of a configuration rule and a scheduled task.

7. The system for management of a network of devices and resources via a computer network according to claim 1, wherein at least one policy is a scheduled task and wherein the agent causes performance of the task when the scheduled task is to be performed.

8. The system for management of a network of devices and resources via a computer network according to claim 1, wherein the policy orchestrator server includes a software repository adapted to be selectively transmitted to the device via the agent corresponding to the device.

9. The system for management of a network of devices and resources via a computer network according to claim 1, wherein the policy orchestrator server includes an agent installation module adapted to be transmitted to the device for installation of the corresponding agent on the device.

10. The system for management of a network of devices and resources via a computer network according to claim 1, wherein each agent includes a task execution component for causing performance of a scheduled task at a scheduled time, a policy enforcement component for enforcing policies applicable to resources of the corresponding device, a property collection component for collecting and storing properties of the corresponding resources of the device and for transmitting the properties to the policy orchestrator server, and an event collection component for collecting and storing event data and for transmitting the event data to the policy orchestrator server.

11. A method for management of a network of devices and resources available to the devices via a computer network, comprising:
determining a hierarchical tree structure based upon locations of devices in a network topology, each device being a node in the hierarchical tree structure;
determining policies for each node in the hierarchical tree structure to be enforced by an agent corresponding to each node, the agent being in communication with the device and the resources corresponding to the device; and
communicating the policy to the corresponding agent; and
wherein the policies corresponding to the resources of each device are selectively inherited along the hierarchical tree structure of the network directory.

12. The method for management of a network of devices and resources via a computer network according to claim 1, further comprising enforcing the polices by the agent upon the corresponding device and resources available to the device.

13. The method for management of a network of devices and resources via a computer network according to claim 11, further comprising:
transmitting an agent installation package to the corresponding device;
installing the agent on the device; and
transmitting a message by the agent to the policy orchestrator server, the message containing properties of the device, the agent being adapted to enforce the policies corresponding to the resources contained in the network directory.

14. The method management of computer application via a computer network according to claim 11, further comprising selectively displaying the hierarchical tree structure and the policies stored in the network directory by a management console in communication with the network directory and the policy orchestrator server, the management console providing a user interface.

15. The method management of computer application via a computer network according to claim 14, further comprising dynamically determining the policy of a selected node of the hierarchical tree structure by the management console.

16. The method management of computer application via a computer network according to claim 15, wherein the dynamic determining includes reading policies of nodes along a path of nodes from a root of the hierarchical tree structure down to the selected node and overwriting previously written policies upon reading conflicting policies at each node along the path of nodes.

17. The method management of computer application via a computer network according to claim 15, wherein the dynamic determining includes reading policies of nodes along a path of nodes from the policies of the selected node up to the policies of a root of the hierarchical tree structure.

18. The method for management of a network of devices and resources via a computer network according to claim 11, wherein each policy is selected from the group consisting of a configuration rule and a scheduled task.

19. A method for management of a network of devices and resources via a computer network according to claim 11, wherein when the policy is a scheduled task, further comprising causing performance of the task by the agent when the scheduled task is to be performed.

20. A method for management of a network of devices and resources via a computer network according to claim 11, further comprising selectively transmitting data from a software repository of the policy orchestrator server to the device via the agent corresponding to the device.

21. A method for management of a network of devices and resources via a computer network according to claim 11, further comprising transmitting an agent installation module by the policy orchestrator server to the device for installation of the corresponding agent on the device.

22. A computer program product for management of a network of devices and resources available to the devices via a computer network, comprising:
computer code that determines a hierarchical tree structure based upon locations of devices in a network topology, each device being a node in the hierarchical tree structure;
computer code that determines policies for each node in the hierarchical tree structure to be enforced by an agent corresponding to each node, the agent being in communication with the device and the resources corresponding to the device; and
computer code that communicates the policy to the corresponding agent;
wherein the policies corresponding to the resources of each device are selectively inherited along the hierarchical tree structure of the network directory; and
a computer readable medium that stores said computer codes.

23. The computer program product for management of a network of devices and resources via a computer network according to claim 22, further comprising computer code that enforces the polices upon the corresponding device and resources available to the device.

24. The computer program product for management of a network of devices and resources via a computer network according to claim 22, further comprising:
computer code that transmits an agent installation package to the corresponding device;
computer code that installs the agent on the device; and
computer code that transmits a message by the agent to the policy orchestrator server, the message containing properties of the device, the agent being adapted to enforce the policies corresponding to the resources contained in the network directory.

25. The computer program product for management of a network of devices and resources via a computer network according to claim 22, further comprising computer code that selectively displays the hierarchical tree structure and the policies stored in the network directory in communication with the network directory and the policy orchestrator server, the management console providing a user interface.

26. The computer program product for management of a network of devices and resources via a computer network according to claim 25, further comprising computer code that dynamically determines the policy of a selected node of the hierarchical tree structure by the management console.

27. The computer program product for management of a network of devices and resources via a computer network according to claim 26, wherein the computer code that dynamically detmines includes computer code that reads policies of nodes along a path of nodes from a root of the hierarchical tree structure down to the selected node and computer code that overwrites previously written policies upon reading conflicting policies at each node along the path of nodes.

28. The computer program product for management of a network of devices and resources via a computer network according to claim 26, wherein the computer code that dynamically determines includes computer code that reads policies of nodes along a path of nodes from the policies of the selected node up to the policies of a root of the hierarchical tree structure.

29. The computer program product for management of a network of devices and resources via a computer network according to claim 22, wherein each policy is selected from the group consisting of a configuration rule and a scheduled task.

30. The computer program product for management of a network of devices and resources via a computer network according to claim 22, wherein when the policy is a scheduled task, further comprising computer code that causes performance of the task by the agent when the scheduled task is to be performed.

31. The computer program product for management of a network of devices and resources via a computer network according to claim 22, further comprising computer code that selectively transmits data from a software repository of the policy orchestrator server to the device via the agent corresponding to the device.

32. The computer program product for management of a network of devices and resources via a computer network according to claim 22, further comprising computer code that transmits an agent installation module by the policy orchestrator server to the device for installation of the corresponding agent on the device.

33. A computer program product for management of a network of devices and resources available to the devices via a computer network, comprising:
computer code that contains a network directory defining a hierarchical tree structure containing nodes corresponding to the network of devices and defining policies corresponding to and to be enforced upon the resources available to the devices;
computer code that facilitates communication between a policy orchestrator server and the network directory to facilitate accessing data from and storing data to the network directory, the data relating to the nodes of the hierarchical tree structure corresponding to the devices and to the policies corresponding to the resources;
computer code that facilitates communication between an agent and the policy orchestrator server and the resources corresponding to the device, the agent computer code being adapted to enforce the policies corresponding to the resources contained in the network directory, wherein the policies corresponding to the resources of each device are selectively inherited down the hierarchical tree structure of the network directory; and
a computer readable medium that stores said computer codes.
